(19) United States
(12) Patent Application Publication
(10) Pub. No.: US 2007/0093325 A1
(43) Pub. Date: Apr. 26, 2007

(54) Generator driving apparatus for hybrid vehicle

(76) Inventor: Seung-Ju Lee, Jeollabuk-do (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/299,385

(22) Filed: Dec. 8, 2005

(30) Foreign Application Priority Data
Oct. 25, 2005 (KR) 10-2005-0100957

(51) Int. Cl. F16H 61/00; F16H 55/56

(52) U.S. Cl. 474/70; 474/8; 474/18

(57) ABSTRACT

A generator driving apparatus for a hybrid vehicle includes an engine pulley mounted at an engine crankshaft. A variable pulley is mounted at a rotational shaft of a motor-generator and is connected via a belt to the engine pulley. An actuator operates the variable pulley. Under such construction, the revolutions per minute of the motor-generator varies according to the deceleration condition of the vehicle, thereby greatly increasing the engine deceleration effect and electric storage efficiency of an accumulator.

### CROSS-REFERENCE TO RELATED APPLICATIONS

The present application is based on, and claims priority from, Korean Application Serial Number 10-2005-0100957, filed on Oct. 25, 2005, the disclosure of which is hereby incorporated by reference herein in its entirety.

### FIELD OF THE INVENTION

The present invention relates to an apparatus that drives a generator of a hybrid vehicle adapted to vary the rotation speed of a rotational shaft of a motor-generator according to the deceleration condition of the vehicle.

### BACKGROUND OF THE INVENTION

A Hybrid Electric Vehicle (HEV) generally has two sources of propulsion—the electric and internal combustion engine that burns diesel, gasoline, or the like.

The hybrid vehicle employs a motor-generator connected via a belt to an engine crankshaft for serving as both the motor and generator by switching into a motor mode and generator mode.

In the generator mode of the motor-generator, the electric energy is generated at the motor-generator by the rotational force of the engine. During a vehicle deceleration, the energy is stored by the operation of the motor-generator and an engine deceleration function is provided.

However, as the conventional motor-generator is directly connected to the engine, the electric storage efficiency can not be maximized at each deceleration condition of the vehicle. Furthermore, the engine deceleration can not properly function.

### SUMMARY OF THE INVENTION

Embodiments of the present invention provide a variable pulley at a rotational shaft of a motor-generator and vary the revolutions per minute (rpm) of the motor-generator in accordance with the deceleration condition of the vehicle, thus optimizing the engine deceleration and electric storage of an accumulator.

A generator driving apparatus for a hybrid vehicle includes an engine pulley mounted at an engine crankshaft. A variable pulley is mounted at a rotational shaft of a motor-generator and connected via a belt to the engine pulley. An actuator operates the variable pulley.

### BRIEF DESCRIPTION OF THE DRAWINGS

For a better understanding of the nature and objects of the present invention, reference should be made to the following detailed description with the accompanying drawings, in which:

FIG. 1 is a constitutional view of a hybrid vehicle employing a generator driving apparatus according to an embodiment of the present invention;

FIG. 2a is a cross-sectional view illustrating a state of a variable pulley, mounted at a generator driving apparatus of a hybrid vehicle according to an embodiment of the present invention, during a slow deceleration of the vehicle;

FIG. 2b illustrates a radius of a V-belt in the state of FIG. 2a;

FIG. 3a is a cross-sectional view illustrating a state of a variable pulley, mounted at a generator driving apparatus of a hybrid vehicle according to an embodiment of the present invention, during a sudden deceleration of the vehicle; and

FIG. 3b illustrates a radius of a V-belt in the state of FIG. 3a.

### DETAILED DESCRIPTION OF THE PREFERRED EMBODIMENTS

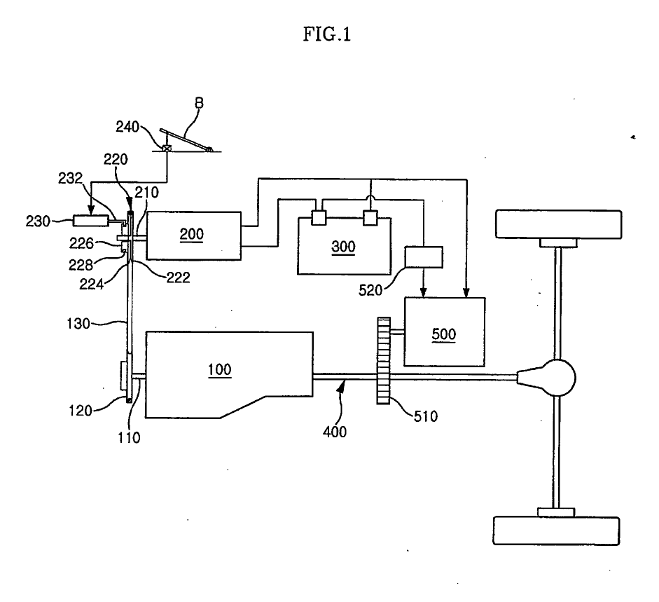

Referring to FIG. 1, a hybrid vehicle employing a generator driving apparatus is equipped with an engine 100, and a motor-generator 200 that is connected to engine 100 and functions as a motor and generator. An accumulator 300 drives motor-generator 200 and stores the electric energy generated from motor-generator 200. A motor 500 is connected to a driving shaft 400 and rotates driving shaft 400 by being rotated via motor-generator 200 or accumulator 300.

Motor 500 is coupled via a power transmission means 510 to driving shaft 400. Power transmission means 510 includes a gear or a belt-pulley. Motor 500 rotates via motor-generator 200 or accumulator 300 and is equipped with a restricting means 520 therebetween. Restricting means 520 rotates motor 500 for operating driving shaft 400 only if necessary (i.e., only when the vehicle is in motion or accelerates).

A crankshaft 110 of engine 100 is coupled with an engine pulley 120, and a rotational shaft 210 of motor-generator 200 is equipped with a variable pulley 220 connected to engine pulley 120. Variable pulley 220 is mounted at one side thereof with an actuator 230 that operates variable pulley 220. A brake pedal (B) is provided with a brake pedal sensor 240 detecting the depressed degree of the brake pedal (B).

Engine pulley 120 is connected with variable pulley 220 through a belt 130. Engine pulley 120 and variable pulley 220 are, respectively, formed with a V-shaped groove at the periphery thereof so that belt 130 connecting engine pulley 120 and variable pulley 220 is preferably a V-belt formed with the V-shaped groove.

The contact area of engine pulley and variable pulley 120 and 220 with belt 130 may increase by using V-belt 130, thus raising the frictional force and the power transmission efficiency thereby.

In comparison with the conventional flat belt, V-belt 130 facilitates the adjustment of the belt radius. This will be described later in detail.

Variable pulley 220 is composed of a fixed pulley 222 and moving pulley 224, wherein fixed pulley 222 is fixed at rotational shaft 210 of motor-generator 200 and rotates with rotational shaft 210, and moving pulley 224 is installed at rotational shaft 210 of motor-generator 200 and moves on rotational shaft 210 by means of actuator 230.

Fixed pulley 222 and moving pulley 224 are shaped to be tapered off toward the contact area thereof so as to decrease the diameter thereat. That is, when fixed pulley 222 and moving pulley 224 contact with each other, the periphery thereof forms a V-shaped groove. Moving pulley 224 is formed at one side thereof (the opposite side from where it contacts fixed pulley 222) with a cylindrical protrusion 226 having a ring-type groove 228 at the periphery thereof.

Groove 228 is inserted by one end of an actuator rod 232. When actuator rod 232 is inserted into or withdrawn from groove 228 by the operation of actuator 230, moving pulley 224 connected with actuator rod 232 moves on rotational shaft 210 of motor-generator 200.

Brake pedal sensor 240 at the brake pedal (B) detects the depressed degree of the brake pedal and changes the amount of movement of actuator rod 232 corresponding to the detected degree. That is, brake pedal sensor 240 adjusts the movement of moving pulley 224 connected to actuator rod 232.

A revolutions per minute (rpm) variable procedure of the generator driving apparatus for the hybrid vehicle is as follows.

As described above, the generator driving apparatus of the hybrid vehicle according to one embodiment of the present invention includes engine pulley 120, and variable pulley 220 connected via V-belt 130 to engine pulley 120. Variable pulley 220 is composed of fixed pulley 222 secured at rotational shaft 210 of motor-generator 200, and moving pulley 224 that moves on rotational shaft 210 via actuator 230.

When the brake pedal (B) is depressed, actuator 230 separates moving pulley 224 from fixed pulley 222 for a predetermined distance, and V-belt 130 moves toward the center of variable pulley 220. Therefore, the radius of belt 130 gets smaller and variable pulley 220 increases in rpm compared to that of engine pulley 120.

In case actuator 230 moves moving pulley 224 toward fixed pulley 222, V-belt 130 moves from the center of variable pulley 220 toward the periphery thereof, contributing to an increase of the radius of belt 130 and a decrease of the rpm of variable pulley 220.

Variable pulley 220 is typically smaller than or equal to engine pulley 120 in diameter. If moving pulley 224 contacts fixed pulley 222 and rotates together, the rpm of variable pulley 220 is slightly higher than or equal to the rpm of engine pulley 120.

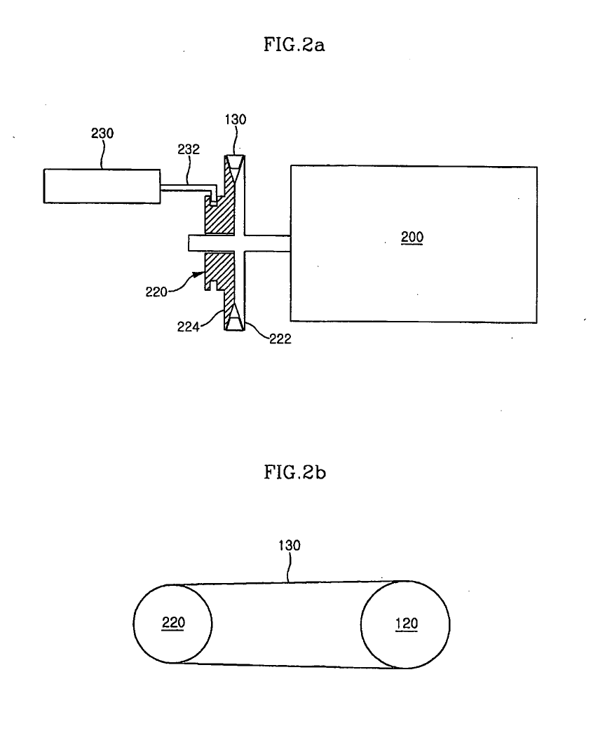

As illustrated in FIG. 2a, if brake pedal sensor 240 detects that the vehicle is being slowly decelerated, then actuator 230 withdraws actuator rod 232 from groove 228 for allowing moving pulley 224 to make a contact with fixed pulley 222. V-belt 130 moves toward the outmost portion of variable pulley 220 as shown in the drawing, thus maximizing the radius of the belt. The belt radii at engine pulley 120 and variable pulley 220 are almost identical to each other in diameter (see FIG. 2b); therefore, the rpms of engine pulley 120 and variable pulley 220 are almost the same. Since the rpm of engine pulley 120 is nearly identical to that of variable pulley 220, the brake force of engine 100 through motor-generator 200 is weakened.

Shortly, when the vehicle slowly decelerates, actuator 230 operates in the state that the rpm of engine 100 has decreased below the predetermined value, and thus, engine pulley 120 and variable pulley 220 are almost identical in rpm to each other, and the brake force of the engine via motor-generator 200 is weak.

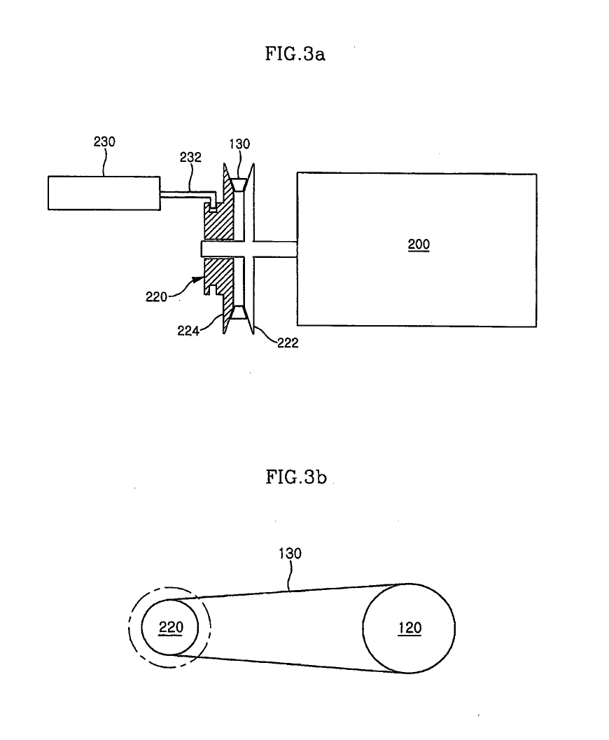

In reference to FIG. 3a, if brake pedal sensor 240 detects a sudden acceleration of the vehicle, actuator 230 inserts actuator rod 232 into groove 228 for distancing moving pulley 224 from fixed pulley 222. V-belt 130 moves toward the center of variable pulley 220, thus minimizing the radius of the belt.

The belt radius at variable pulley 220 is much smaller than that of engine pulley 120 (see FIG. 3b). As variable pulley 220 rotates faster than engine pulley 120, the brake force of engine 100 via motor-generator 200 is weakened.

Assuming that the engine 100 is in 100 rpm and the motor-generator is preferably in 80 rpm in the event of a slow deceleration of the vehicle, the rpm ratio between engine pulley 120 and variable pulley 220 is equal to 1:0.8. The diameters of engine pulley 120 and variable pulley 220 should be nearly identical to each other, and engine 100 at low rpm can decrease in speed even with a weak brake force.

In case of a sudden acceleration of the vehicle, if the engine rpm is equal to 800 and the motor-generator rpm is equal to 80, then the rpm ratio between engine pulley 120 and variable pulley 220 is 1:0.1. Accordingly, variable pulley 220 should be 1/10 in diameter than engine pulley 110, and a large brake force is required for braking engine 100 having a high rpm.

Hence, the generator driving apparatus of the hybrid vehicle thus constructed can obtain a superior deceleration effect by varying the rpm of motor-generator 200 corresponding to the deceleration condition of the vehicle and optimize the electric storage efficiency of the accumulator.

The technical concept of the present invention is not limited to the above embodiment but should be determined by a logical interpretation on the basis of the claims of the present invention.

As apparent from the foregoing, there is an advantage in that the variable pulley is mounted at the rotational shaft of the motor-generator, and the rpm of the motor-generator varies according to the deceleration condition of the vehicle, thereby remarkably increasing the engine deceleration effect and electric storage efficiency of the accumulator.

What is claimed is:

1. A generator driving apparatus for a hybrid vehicle, comprising:
an engine pulley mounted at an engine crankshaft;
a variable pulley mounted at a rotational shaft of a motor-generator and connected via a belt to said engine pulley; and
an actuator that operates said variable pulley.

2. The apparatus as defined in claim 1, further comprising a brake pedal sensor that detects a depression of a brake pedal, wherein said actuator adjusts a movement of said variable pulley corresponding to the depressed degree of said brake pedal.

3. The apparatus as defined in claim 1, wherein said variable pulley includes:
a fixed pulley secured at said rotational shaft of said motor-generator; and
a moving pulley mounted at said rotational shaft and moving on said rotational shaft via said actuator, wherein a belt radius varies in accordance with a movement of said moving pulley.
